(19) United States
(12) Patent Application Publication
(10) Pub. No.: US 2015/0237457 A1
(43) Pub. Date: Aug. 20, 2015

(54) SIM BASED DATA OPERATION METHOD AND ELECTRONIC DEVICE SUPPORTING THE METHOD

(71) Applicant: Samsung Electronics Co., Ltd., Suwon-si (KR)

(72) Inventors: Chul Ho YU, Gumi-si (KR); Seung Kwon PARK, Gumi-si (KR); In Soon KIM, Gumi-si (KR); Ki Chul SONG, Gumi-si (KR); Ji Woo LEE, Gumi-si (KR)

(21) Appl. No.: 14/606,598

(22) Filed: Jan. 27, 2015

(30) Foreign Application Priority Data
Feb. 18, 2014 (KR) 10-2014-0018215

(51) Int. Cl. H04W 4/00; H04W 8/18

(52) U.S. Cl. CPC H04W 4/003; H04W 8/183

(57) ABSTRACT

An electronic device is provided. The electronic device includes a Subscriber Identity Module (SIM) card configured to store SIM information, a control module configured to combine the SIM information with stored address information on a server device to create combined address information, to control a connection with the server device based on the combined address information, and to control a reception of a list of applications comprising information related to application installation or update corresponding to a type of the SIM information, and a communication module configured to establish communication with the server device.

### CROSS-REFERENCE TO RELATED APPLICATION(S)

This application claims the benefit under 35 U.S.C. §119(a) of a Korean patent application filed on Feb. 18, 2014, in the Korean Intellectual Property Office and assigned Serial No. 10-2014-0018215, the entire disclosure of which is hereby incorporated by reference.

### TECHNICAL FIELD

The present disclosure relates to Subscriber Identity Module (SIM) based data operation.

### BACKGROUND

Electronic devices have a communication function and many portable electronic devices have been distributed, so many people are now using the electronic devices. Such electronic devices often include a touch function as an input unit so that a user input may be easily performed.

Typical electronic devices as described above use a Subscriber Identity Module (SIM) card in order to identify a network by an operator in relation to using a communication service. Thus, without purchasing a new electronic device, it is possible to use a communication service provided by each operator network through SIM card replacement. Users may have favorite applications installed on the electronic device.

However, when a SIM card is replaced, there is inconvenience in that a user may be required to search for, download, and then install each desired application one by one because a corresponding electronic device may have no appropriate applications.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a Subscriber Identity Module (SIM) based data operation method and an electronic device supporting the method that support easier data installation and operation by providing at least a portion of application information suitable for a SIM card characteristic according to SIM information analysis.

In accordance with an aspect of the present disclosure, an electronic device is provided. The electronic device includes a SIM card configured to store SIM information, a control module configured to combine the SIM information with stored address information on a server device to create combined address information, to control a server device connection based on the combined address information, and to control a reception of a list of applications including information related to application installation or update corresponding to a type of the SIM information, and a communication module configured to establish communication in a server device connection process.

In accordance with an aspect of the present disclosure, a SIM based data operation method is provided. The method includes collecting SIM information on a SIM card of an electronic device, combining, by the electronic device, collected SIM information with stored address information of a server device to create combined address information, connecting, by the electronic device, to the server device based on the combined address information, and receiving, by the electronic device, a list of applications including information related to application installation or update according to a characteristic of the SIM information.

In accordance with an aspect of the present disclosure, a server device is provided. The device includes a server communication module configured to establish a communication channel with an electronic device connecting to a server device based on combined address information obtained by combining SIM information with stored address information on the server device, a server control module configured to extract the SIM information from the combined address information, and to transmit a list of applications including information related to the installation or update of at least one application corresponding to the characteristic of extracted SIM information, to the electronic device, and a server storage module configured to store information related to the installation or update of the application.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a Subscriber Identity Module (SIM) card based data operation system according to an embodiment of the present disclosure.

FIG. 2 shows a signal flow between the device components of a data operation system according to an embodiment of the present disclosure.

FIG. 3 shows a combined Uniform Resource Locator (URL) information structure according to an embodiment of the present disclosure.

FIG. 4 shows a server device according to an embodiment of the present disclosure.

FIG. 5 shows an electronic device according to an embodiment of the present disclosure.

FIG. 6 shows a control module according to an embodiment of the present disclosure.

FIG. 7 shows a method of operating an electronic device according to an embodiment of the present disclosure.

FIG. 8 shows a screen interface according to an embodiment of the present disclosure.

FIG. 9 shows a screen interface according to another embodiment of the present disclosure.

FIG. 10 shows a screen interface according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expression “include” or “may include” that may be used in the present disclosure indicates the presence of a disclosed corresponding function, operation or component but does not exclude one or more functions, operations or components in addition. Also, in the present disclosure, it should be understood that the term “includes” or “has” indicates the presence of characteristics, numbers, steps, operations, components, parts or combinations thereof represented in the present disclosure but does not exclude the presence or addition of one or more other characteristics, numbers, steps, operations, components, parts or combinations thereof.

In various embodiments of the present disclosure, the expression “or” or “at least one of A and/or B” includes any and all combinations of enumerated words. For example, the expression “A or B” or “at least one of A and/or B” may include A, B, or both A and B.

In the present disclosure, the expressions “a first”, “a second”, “firstly”, “secondly”, etc., may modify various components of the present disclosure but do not limit corresponding components. For example, the expression above does not limit the order and/or importance of corresponding components. The expression above may be used to distinguish one component from another component. For example, without departing from the scope of rights of the present disclosure, a first component may be called a second component and similarly, the second component may also be called the first component.

When any component is referred to as being “associated”, “connected” or “accessed'” to another component, it should be understood that the former can be directly connected or accessed to the latter, or there may be another component in between. On the contrary, when any component is referred to as being “directly connected” or “directly accessed” to another component, it should be understood that there may be no other component in between.

The terms used in the present disclosure are used only to describe specific embodiments and are not intended to limit the present disclosure. The terms in singular form includes the plural form unless otherwise specified.

Unless otherwise defined herein, all terms used herein including technical or scientific terms have the same meanings as those generally understood by a person skilled in the art. Terms defined in generally used dictionaries should be construed to have meanings matching contextual meanings in the conventional art and should not be construed as having an ideal or excessively formal meaning unless otherwise defined herein.

An electronic device according to the present disclosure may include a device that supports Subscriber Identity Module (SIM) card operation. For example, the electronic device may include at least one of a smart phone, a tablet Personal Computer (PC), a mobile phone, a video phone, an e-book reader, a desktop PC, a laptop PC, a net book computer, a Personal Digital Assistant (PDA), a Portable Multimedia Player (PMP), a digital audio player, a mobile medical device, a camera, and a wearable device (e.g., a Head-Mounted-Device (HMD) such as electronic glasses, electronic clothing, an electronic bracelet, an electronic necklace, an electronic appcessory, an electronic tattoo, or a smart watch).

According to some embodiments, the electronic device may be a smart home appliance having a SIM card. The smart home appliance may include, for example, at least one of a television (TV), a Digital Versatile Disk (DVD) player, an audio set, a refrigerator, an air conditioner, a cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic frame.

According to some embodiments, the electronic device may include at least one of various medical devices (e.g., a Magnetic Resonance Angiography (MRA) device, a Magnetic Resonance Imaging (MRI) device, a Computed Tomography (CT) device, a camera, and an ultrasonicator), a navigation system, a Global Positioning System (GPS) receiver, an Event Data Recorder (EDR), a Flight Data Recorder (FDR), a car infotainment device, electronic equipment for a ship (e.g., a navigation device or gyro compass for a ship), avionics, a security device, a head unit for a vehicle, an industrial or home robot, a financial institution's Automated Teller Machine (ATM) or a store's Point Of Sales (POS) device.

According to some embodiments, the electronic device may include at least one of a portion of a building/structure or furniture including a sensor panel or a touch panel, an electronic board, an electronic signature receiving device, a projector, and various measurement devices (e.g., a water, electricity, gas or electric wave measurement device) that include a SIM card. The electronic device according to the present disclosure may be one or more combinations of the above-described various devices. Moreover, the electronic device according to the present disclosure may be a flexible device. Also, it is obvious to a person skilled in that art that the electronic device according to the present disclosure is not limited to the above-described devices.

In the following, electronic devices according to various embodiments are discussed with reference to the accompanying drawings. The term “user” used in various embodiments may mean a person who uses an electronic device or a device (e.g., an artificial intelligence electronic device) that uses the electronic device.

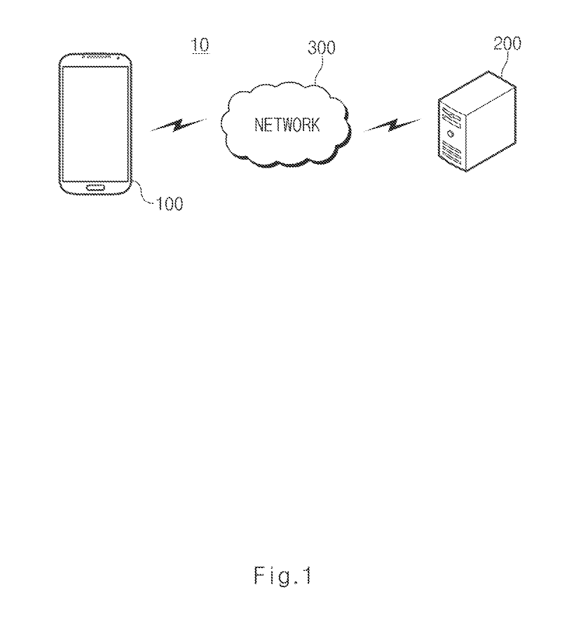

FIG. 1 shows a SIM card based data operation system according to an embodiment of the present disclosure.

Referring to FIG. 1, a SIM card based data operation system 10 may include an electronic device 100 and a server device 200. Furthermore, the SIM card based data operation system 10 may further include a data transmission and reception network 300 between the electronic device 100 and the server device 200.

In the above-described data operation system 10, the electronic device 100 may connect to the server device 200 based on server device address information (such as combined Uniform Resource Locator (URL) information generated by combining URL information) that provides SIM information on a SIM card and specific application installation related information. The application installation related information may include various pieces of information related to application installation. For example, the application installation related information may include data related to allocating a memory when installing an application, control data related to application execution, screen data to be displayed on a display module when executing an application, and audio data to be output when executing an application. The server device 200 may extract SIM information from combined URL information, create a list of applications corresponding to the SIM information and transmit the list to the electronic device 100. Thus, the data operation system 10 may shorten a time needed for searching for an application by providing a list of applications that a corresponding user has previously installed, based on SIM information on the electronic device 100. Also, the data operation system 10 may more easily receive and install a plurality of applications by providing a plurality of linked applications corresponding to specific SIM information as a package.

The electronic device 100 may connect to the server device 200 through the network 300. The electronic device 100 may include at least one SIM card or use at least a piece of SIM information. The electronic device 100 may recognize at least a piece of SIM information and whether an application related to SIM information is installed. When a related application is not installed, the electronic device 100 may create a combined URL by using a SIM information parameter such as an Integrated Circuit Card-IDentification (ICC-ID) and designated application address information. The electronic device 100 may connect to the server device 200 through the combined URL and receive a list of applications related to SIM. The electronic device 100 may download and install a specific application based on specified application address information in response to selecting at least one application item included in the list of applications.

The server device 200 may extract SIM information on a corresponding electronic device 100 from a combined URL when the electronic device 100 that connects based on the combined URL connects to the server device. The server device 200 may search for applications corresponding to extracted SIM information. The server device 200 may transmit a list of applications created with found applications, to the electronic device 100. When receiving specific application item selection information from the electronic device 100, the server device 200 may provide corresponding application installation related information to the electronic device 100.

The network 300 may support the communication channel establishment between the electronic device 100 and the server device 200. The network 300 may support a connection to the server device 200 based on a combined URL created by the electronic device 100. The network 300 may transfer the list of applications created by the server device 200 to the electronic device 100. The network may transmit application item selection information determined in response to selection from the list of applications, to the server device 200. The network 300 may transmit application installation related information transmitted by the server device 200 to the electronic device 100. As described above, the network 300 may establish a communication channel for connecting the electronic device 100 to the server device 200 based on a combined URL and a communication channel related to transmitting a list of applications, application item selection information, and application installation information. In this process, the above-described communication channel is not limited to a specific communication scheme. For example, the network 300 may support the above-described communication channel establishment based on at least one communication scheme such as a mobile communication scheme, an internet communication scheme, and a multi-generation communication scheme.

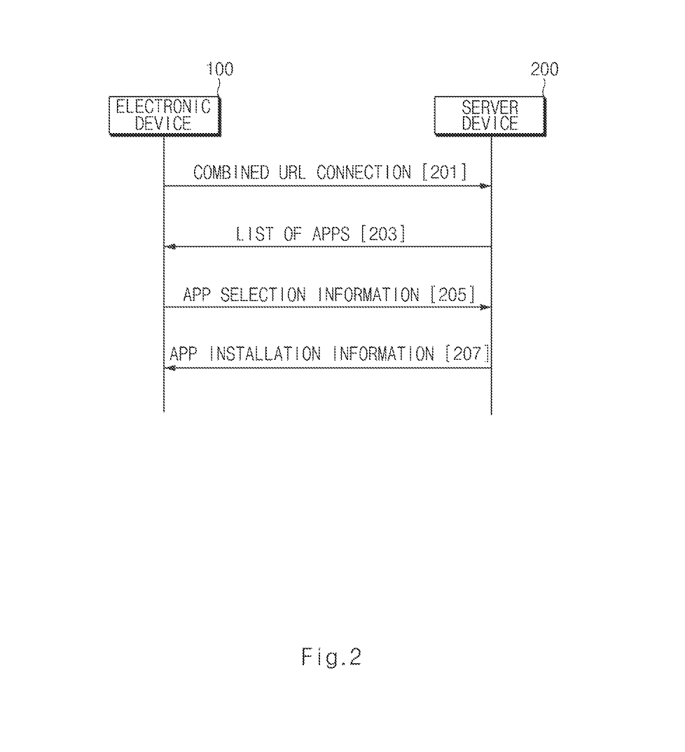

FIG. 2 shows a signal flow between the device components of a data operation system according to an embodiment of the present disclosure.

Referring to FIG. 2, when a SIM card is inserted at the electronic device 100 or an input event related to SIM card related application installation occurs in the operation method of a data operation system, the electronic device 100 may create a combined URL. In this process, the electronic device 100 may combine SIM information with server device address information on a specific application written in the SIM information, to create a combined URL. When the combined URL information is generated, the electronic device 100 may perform a connection to the server device 200 based on the combined URL in operation 201.

When a specific electronic device 100 connects based on the combined URL, the server device 200 may extract SIM information from the combined URL. The server device 200 may search for specific applications needed corresponding to the extracted SIM information. In this context, the server device 200 may store information on specific applications to be provided by SIM information. The server device 200 may create a list of applications based on found applications and transmit the list to the electronic device 100 in operation 203.

The electronic device 100 may output a received list of applications. The electronic device may transmit application item selection information to the server device 200 in operation 205 when at least one of applications in the list is selected. The server device 200 may search for application installation information corresponding to application item selection information transmitted by the electronic device 100 and transmit the application installation information to the electronic device 100 in operation 207. The electronic device 100 may store application installation information provided by the server device 200 and process the installation operation of a corresponding application.

The above-described operation system 10 may use SIM information having various functions to provide an optimized application to the electronic device 100. In an embodiment, the data operation system 10 may identify a specific network service operator by using Mobile Country Code/Mobile Network Code (MCC/MNC) information among SIM information and provide an application package necessary to a customer from the operator aspect. In an embodiment, the data operation system 10 may check SIM information that is being currently data-serviced or may be serviced by the electronic device 100 having a plurality of SIMs, and provide an application related to a corresponding SIM. In an embodiment, when SIM information includes Near Field Communication (NFC) or financial transaction related information, the data operation system 10 may provide an e-wallet that may use a corresponding SIM, or a specific financial application. In an embodiment, when SIM information includes network limitation information such as data sharing, the data operation system 10 may transmit corresponding information to a server and provide an application related to an operator associated with a second electronic device connected to a data sharing electronic device. In an embodiment, when SIM information includes an account associated with a specific application store, the data operation system 10 may provide an application necessary to a user form a corresponding application store aspect.

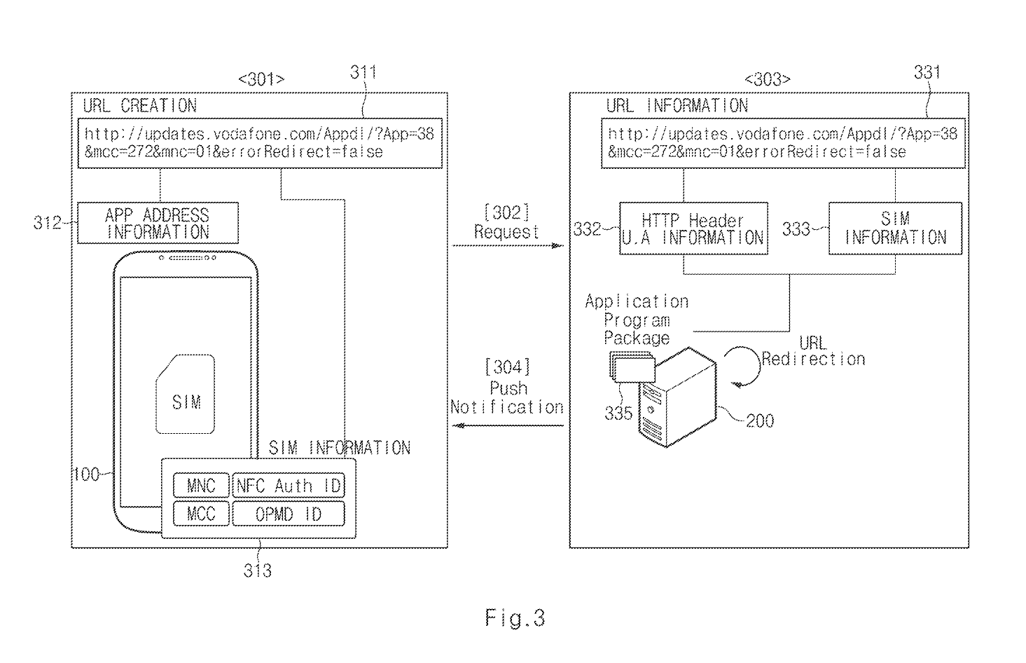

FIG. 3 shows a combined URL information structure according to an embodiment of the present disclosure.

Referring to FIG. 3, the electronic device 100 may check SIM information 313 when a specific event occurs as in state 301. For example, the electronic device 100 may check SIM information 313 when a new SIM card is inserted, or a stored SIM information 313 based application installation request event occurs. The SIM information 313 may include various pieces of information according to SIM cards inserted into the electronic device 100. For example, the SIM information 313 may include Mobile Network Code/Mobile Country Code (MNC/MCC), Near Field Communication Authentication ID (NFC Auth ID), and One-Person Multi-Devices ID (OPMD ID). The electronic device 100 may collect stored application address information 312 providing application installation information and create the combined URL 311 by using application address information 312 and SIM information 313. The electronic device 100 may perform an application installation related connection request in state 302, when the combined URL 311 is created.

The electronic device 100 may combine the SIM information 313 with server device address pre-designated in relation to an application to create the combined URL 311 that may vary depending on the SIM information 313. For example, the electronic device 100 may use MCC/MNC information obtained through the ICC-ID of an inserted SIM to create the combined URL 311 as represented in Table 1 below. The details represented in Table 1 show an example of the combined URL 311 for providing an application for the electronic device 100 using the operator Vodafone located in Ireland. Credit ID or Membership ID may be converted into encrypted information (e.g., random-number employing information) for security and may then be transmitted.

TABLE 1

| Parameter | Definition | Combined URL |
|---|---|---|
| MCC/MNC | Country Code/ | http://updates.vodafone.com/ |
| SPN/GID | Operator | Appdl/?App=38&mcc=272&mnc=01&errorRedirect=false |
| | Information | |
| NFC Auth | Whether NCF | http://updates.vodafone.com/ |
| | service is enabled | Appdl/?App=38&mcc=272&mnc=01&nfcAuth=1&errorRedirect=false |
| | (Boolean) | |
| Credit | Credit ID | http://updates.vodafone.com/ |
| Membership | Membership ID | Appdl/?App=38&mcc=272&mnc=01&nfcAuth=1&authId=NTI4NDA0N2Y0ZmZiN&errorRedirect=false |

The server device 200 may collect User Agent (UA) information 332 and SIM extraction information 333 from combined URL 331 information received while performing URL Redirection, when the electronic device 100 connects thereto through the combined URL 331 as in state 303. The UA information includes information related to the electronic device 100. For example, the UA information may include a main Operating System (OS) and the model name of an electronic device. The server device 200 may create an application program package, or application list, 335 based on the UA information 332 and the SIM extraction information 333. When the application list 335 is created, the server device 200 may provide the application list 335 for the electronic device 100. In this case, the server device 200 may perform a Push Notification as in state 304.

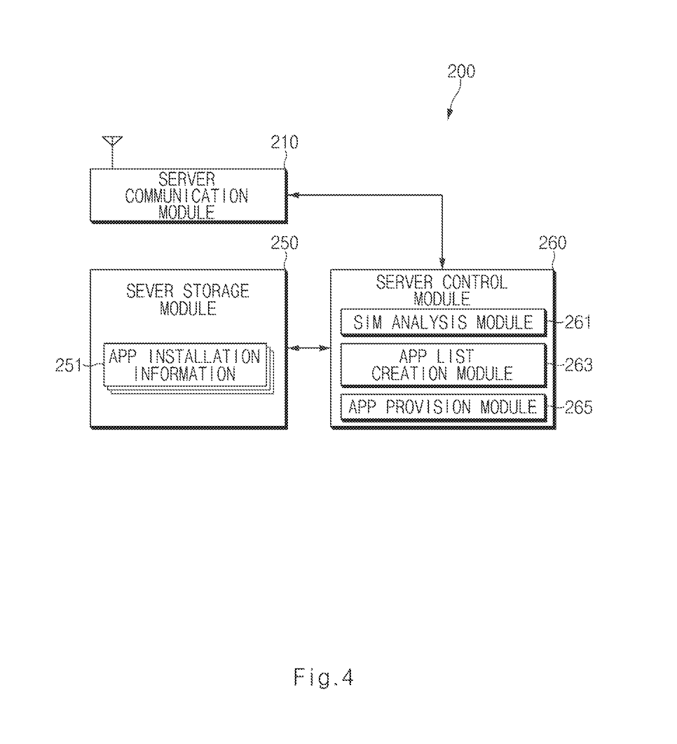

FIG. 4 shows a server device according to an embodiment of the present disclosure.

Referring to FIG. 4, the server device 200 may include a server communication module 210, a server storage module 250, and a server control module 260.

The server communication module 210 may support the communication function of the server device 200. The server communication module 210 may establish a communication channel with the network 300 and support the connection of the electronic device 100. The server communication module 210 may enable the electronic device 100 to connect with combined URL. The server communication module 210 may provide an application list for the electronic device 100 that connects with the combined URL. The server communication module 210 may receive application item selection information from the electronic device 100. The server communication module 210 may transmit, to the electronic device 100, application installation information corresponding to application item selection information according to the control of the server control module 260.

The server storage module 250 may store programs or data associated with the operation of the server device 200. According to an embodiment, the server storage module 250 may store application installation information 251 on a plurality of applications. The application installation information 251 stored in the server storage module 250 may be transmitted, to the electronic device 100, according to the control of the server control module 260. The application installation information 251 stored in the server storage module 250 may be used for creating a list of applications.

The server control module 260 may transfer or process data associated with the operation of the server device 200. For example, the server control module 260 may process the connection of the electronic device 100, the provision of the list of applications of the electronic device 100, or the provision of the application installation information 251. In an embodiment, the server control module 260 may include a SIM analysis module 261, an application list creation module 263, and an application provision module 265.

When the electronic device 100 connects based on the combined URL, the SIM analysis module 261 may extract header information and SIM information from combined URL. In addition, the SIM analysis module 261 may analyze extracted SIM information. For example, the SIM analysis module 261 may check whether extracted SIM information is an OPMD-type SIM, an NFC-type SIM, or a specific operator related SIM. The SIM analysis module 261 may transfer analyzed SIM information to the application list creation module 263.

The application list creation module 263 may receive analyzed SIM information from the SIM analysis module 261. The application list creation module 263 may determine on which application list is created, based on analyzed SIM information. In this context, the server storage module 250 may store information on applications to be provided by SIM information. Thus, the application list creation module 263 may create a list of applications based on information on SIM information based applications stored in the server storage module 250. According to various embodiments, the application list creation module 263 may perform information management on the SIM information based applications of the server storage module 250. For example, when a specific application is newly created, the application list creation module 263 may check the characteristic of a corresponding application, such as an application type or category and determine on which category of SIM information the application will be arranged. For example, characteristic information on an application may be written in header information on the application in the process of creating the application. The application list creation module 263 may transmit a created application list to a corresponding electronic device 100. According to various embodiments, the application list creation module 263 may create an application package item based on pieces of application installation information 251 corresponding to specific SIM information. The application list creation module 263 may include the application package item in a list of applications and provide it for electronic device 100.

The application provision module 265 may receive application item selection information from the list of applications transmitted by the electronic device 100. The application provision module 265 may check application installation information 251 corresponding to received application item selection information, in the server storage module 250. The application provision module 265 may transmit corresponding application installation information 251 to the electronic device 100. According to various embodiments, when application item selection information is application package selection information, the application provision module 265 may transmit, pieces of application installation information 251 corresponding to that application package, to the electronic device 100. In this case, the application provision module 265 may enable pieces of application installation information 251 to be automatically installed in the electronic device 100 successively.

Regarding application package creation, the application provision module 265 may also receive and process pieces of application item selection information from a list of applications. In this context, the application provision module 265 may transfer notification information on an entry to application package installation process to the electronic device 100. The notification information may be individually created to be suitable for information according to the type of installed SIM information. For example, when SIM information includes operator information, Universal Integrated Circuit Card (UICC) information and Orthogonal Frequency Division Multiplexing (OFDM) information, the application provision module 265 may create notification information corresponding to three pieces of SIM information and transmit the information to the electronic device 100. Also, the application provision module 265 may generate and transmit notification information on one integrated package including applications corresponding to operator information, UICC information and OPDM information. The type of applications according to SIM information analysis that the application provision module 265 may provide may be represented in Table 2 below.

TABLE 2

| | Operator SIM | | |
|---|---|---|---|
| SIM Type | (MCC/MNC) | OPMD SIM | UICC (NFC) |
| Examples of | Operator Related | Application List | Smart Wallet, |
| provided | Applications (WIFI | Shared with | Mobile Payment |
| applications | Finder, CALL, | Original Device, | Apps, Credit Card |
| | Customer Center, | Operator App, | App |
| | CLOUD, Appstore, | etc. | |
| | Shopping, etc.) | | |

Examples of provided applications include Operator Related Applications (WIFI Finder, CALL, Customer Center, CLOUD, Appstore, Shopping, etc.), Application List Shared with Original Device, Operator App, Smart Wallet, Mobile Payment Apps, Credit Card App, etc.

The application provision module 265 may provide optimized applications determined through SIM information as a package form to simplify an installation process from a user aspect and enable the electronic device 100 to use less data. In this example, a package includes many applications and may have a form in which the applications are bound to be formed as one installation file.

As described above, according to various embodiments, the server device 200 may include the server communication module that establishes a communication channel with the electronic device 100 connecting based on combined address information formed by combining the SIM information with stored address information on the electronic device 100, the server control module 260 that extracts the SIM information from the combined address information and transmits a list of applications including information associated with the installation and update of at least one application corresponding to the characteristic of extracted SIM information to the electronic device 100, and the server storage module 250 that stores information associated with the installation or update of the application.

According to various embodiments, the server control module 260 may receive and process pieces of application item selection information from a list of applications.

According to various embodiments, the server control module 260 may include, notification information corresponding to at least one of operator information, UICC information and OFDM information, in SIM information, and transmit the notification information to the electronic device 100.

According to various embodiments, the server control module 260 may generate and transmit notification information on one integrated package including all applications corresponding to operator information, UICC information, and OPDM information.

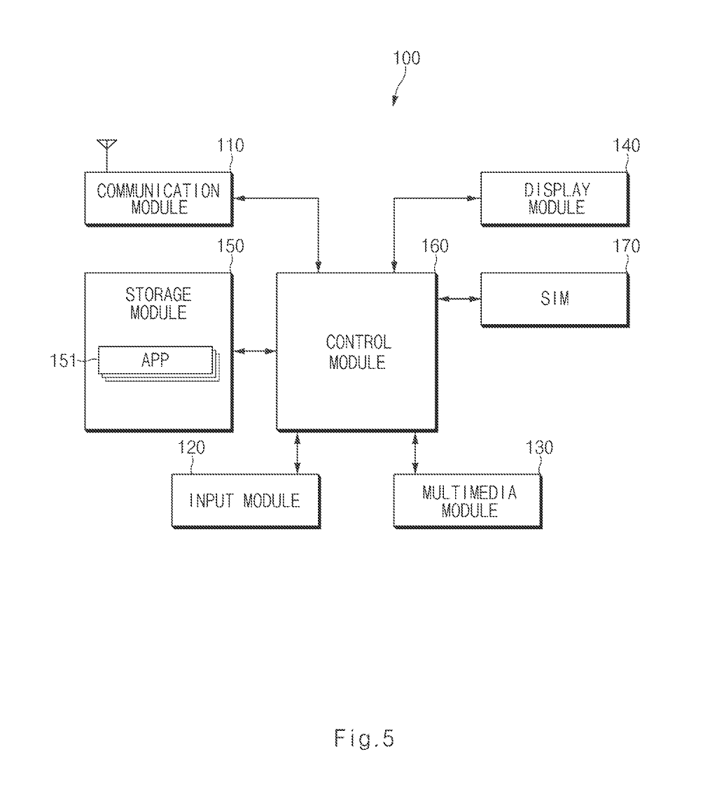

FIG. 5 shows an electronic device according to an embodiment of the present disclosure.

Referring to FIG. 5, the electronic device 100 may include a communication module 110, an input module 120, a multimedia module 130, a display module 140, a storage module 150, a control module 160, and a SIM card 170.

The electronic device 100 may combine SIM information stored in the SIM card 170 with pre-stored server device address information to generate combined URL information and perform a connection to the server device 200 based on the generated information. The electronic device 100 receives a list of applications created based on SIM information from the server device 200 and transmits specific application item selection information to the server device 200 so that the electronic device may easily receive and install application installation information associated with the SIM information.

The communication module 110 may include at least one communication unit associated with a communication function of the electronic device 100. For example, the communication module 110 may include various communication units, such as a mobile communication unit, a broadcast receiving unit such as a Digital Multimedia Broadcasting (DMB) module or a Digital Video Broadcasting-Handheld (DVB-H) module, a short-range communication unit such as an NFC module or ZIGBEE module being a BLUETOOTH module, and a WiFi communication unit. According to an embodiment, the communication module 110 may use a communication channel with the network 300. The communication module 110 may establish a communication channel with the server device 200 based on a combined URL according to the control of the control module 160. According to various embodiments, the communication module 110 may receive a list of applications provided by the server device 200 and display the list of applications on the display module 140. According to various embodiments, the communication module 110 may transmit at least a piece of application item selection information included in the list of applications. According to various embodiments, the communication module 110 may receive application installation information corresponding to a specific application or application package from the server device 200 and provide the information to the control module 160.

The input module 120 may generate an input signal of the electronic device 100. The input module 120 may include at least one of a keypad, a dome switch, a (static pressure/capacitive) touch pad, a jog wheel, and a jog switch, for example. The input module 120 may be realized in a button form on the outside of the electronic device 100 and some buttons may also be realized as the display module 140 having a touch function. According to an embodiment, the input module 120 may include a plurality of keys for obtaining numeric or text information and setting various functions. Such keys may include a menu call key, a screen ON/OFF key, a power ON/OFF key, a volume control key, and a home key.

According to an embodiment, the input module 120 may generate an input signal related to SIM information related application installation, an input signal related to specific application selection from a list of applications, and an input signal instructing to install a corresponding application based on received application installation information. The input module 120 may generate an input signal related to the activation of an installed application. According to various embodiments, the input module 120 may generate an input signal related to selecting at least one application package.

The multimedia module 130 may process an audio signal of the electronic device 100. For example, the multimedia module 130 may transmit an audio signal input from the control module 160 to a Speaker SPK (not shown). The multimedia module 130 may perform the function of transferring an audio signal such as voice input from a microphone MIC (not shown), to the control module 160. The multimedia module 130 may convert an audio signal such as voice received from the microphone MIC into a digital signal and transfer the digital signal to the control module 160.

According to an embodiment, the multimedia module 130 may output a guidance sound related to inserting or removing the SIM card 170 or provide a sound effect. The multimedia module 130 may output audio data related to creating the combined URL, audio data related to connecting to the server device 200, audio data related to the operation of receiving a list of applications from the server 200, audio data related to the operation of selecting an app, and audio data related to receiving and installing application installation information. The multimedia module 130 may output audio data related to disconnecting from the server device 200. The function of outputting audio data as described above may also be left out according to a user choice or a design change.

The display module 140 may display various screens corresponding to functions processed by the electronic device 100. For example, the display module 140 may display a standby screen, a main screen or a lock screen. According to an embodiment, the display module 140 may display a message related to inserting and removing the SIM card 170 or a related screen. The display module 140 may display information on applications that are executed based on the SIM card 170 and are not inserted. The display module 140 may display a screen to perform a connection to the server device 200 based on combined URL, or a screen related to a list of applications received from the server device 200. The display module 140 may receive application installation information corresponding to specific application selection information determined by an input event and display an application installation screen.

According to the rotation direction (or arrangement direction) of the electronic device 100, the above-described display module 140 may support a horizontal-mode screen display and a vertical-mode screen display, and a screen switch display according to the change between the horizontal mode and the vertical mode. The display module 140 may include at least one of a Liquid Crystal Display (LCD), a Thin Film Transistor-LCD (TFT LCD), a Light Emitting Diode (LED), an Organic LED (OLED), an Active Matrix OLED (AMOLED), a flexible display, a bent display, and a 3 Dimensional (3D) display. Some of these displays may be realized as transparent displays that are transparent or optically transferable to enable viewing from the outside.

Also, the display module 140 may be provided as a touch screen and thus used as an input device in addition to an output device. It may be configured to convert a change in pressure applied to a specific part of the display module 140 or in capacitance generated from a specific part of the display module 140 into an electrical input signal. The display module may also be configured to be able to detect pressure when a touch is performed, in addition to a touched location and area. The display module 140 operating as an input device may be configured along with a touch panel and a display panel. The touch panel may be placed on the display panel. The touch panel may be realized in an add-on type in which the touch panel is placed on the display panel, in an in-cell type or on-cell type in which the touch panel is inserted into the display panel. The touch panel transfers a user input responsive to a user gesture relative to the display module 140, to the control module 160. In this example, the user input caused by fingers or a touch unit such as a touch pen may include a touch, multiple touches, a tap, double taps, a long tap, a tap and touch, a drag, a flick, a press, a pinch in, and a pinch out. The above-described user input may be defined as an input event to request for the combined URL creation and sever device 200 connection, an event to select a specific application item of a list of applications, and an input event to request for application installation using specific application installation information.

The above-described display module 140 may further include a touch panel related to operation an electronic pen. For example, the display module 140 may further include an electromagnetic induction type touch panel when the electronic pen uses electromagnetic induction. The display module 140 may provide, a touch event occurring on the touch panel or the electromagnetic induction touch panel, to the control module 160.

The storage module 150 may store various programs and data related to processing and controlling data related to the operation of the electronic device 100. For example, the storage module 150 may store an OS. According to an embodiment, the storage module 150 may store at least one application 151. At least one application 151 of applications 151 stored in the storage module 150 may be an application that operates based on SIM information stored in the SIM card 170. For example, it is possible to include at least one application related to SIM information as described in Table 2. The storage module 150 may receive and store application installation information related to the application 151 from the server device 200. The application 151 stored in the storage module 150 may include program information related to executing specific functions.

The above-described storage module 150 may include, as a storage medium, at least one of flash memory type, hard disk type, micro type and card type (for example, Secure Digital (SD) card or Extreme Digital (XD) card) memories, and Random Access Memory (RAM), Static RAM (SRAM), Read-Only Memory (ROM), Programmable ROM (PROM), Electrically Erasable PROM (EEPROM), Magnetic RAM (MRAM), magnetic disk and optical disk type memories. The electronic device 100 may also operate along with a web storage that performs a storage function of the storage module 150 over the interne.

The SIM card 170 may be a storage device that stores SIM information. The SIM information may include ICC-ID that includes MCC/MNC information. The MCC may mean information on country and MNC may mean information on a service operator. Such MCC/MNC information may be a Public Land Mobile Network (PLMN) ID. Such information may be indicated by numbers. For example, when MCC/MNC is 262/02, 262 may mean Germany and 02 may mean a specific operator within the country. The MCC/MNC information may be used for identifying a country-based operator because it is uniquely allocated based on a country and an operator. The SIM information may include Service Provider Name/Group Infrastructure-Desktop (SPN/GID) information. The SPN and the GID correspond to optional information and may be empty or written in any form. The SPN/GID information may include information related to SIM locking, and a roaming phone may not use a network service from an operator different from corresponding SPN information. The GID may be information corresponding to a password related to SIM locking.

The SIM card 170 may support various UICC functions related to a smart card function, apart from MCC, MNC, SPN, and GID information that are fundamental SIM information. In this context, the SIM information may include SIM-NFC information. The SIM-NFC information may include information on whether it is possible to use NFC, whether a corresponding device has subscribed to a communication company, a membership ID, a credit card list, and main credit card. The above-described SIM card 170 may include a logical SIM form including a security factor in addition to a physical device.

The control module 160 may process and transfer data related to the operation of the electronic device 100 and process and transfer a control signal. According to an embodiment, the control module 160 may create the combined URL, connect to the server device 200, and output a list of applications and process application installation information.

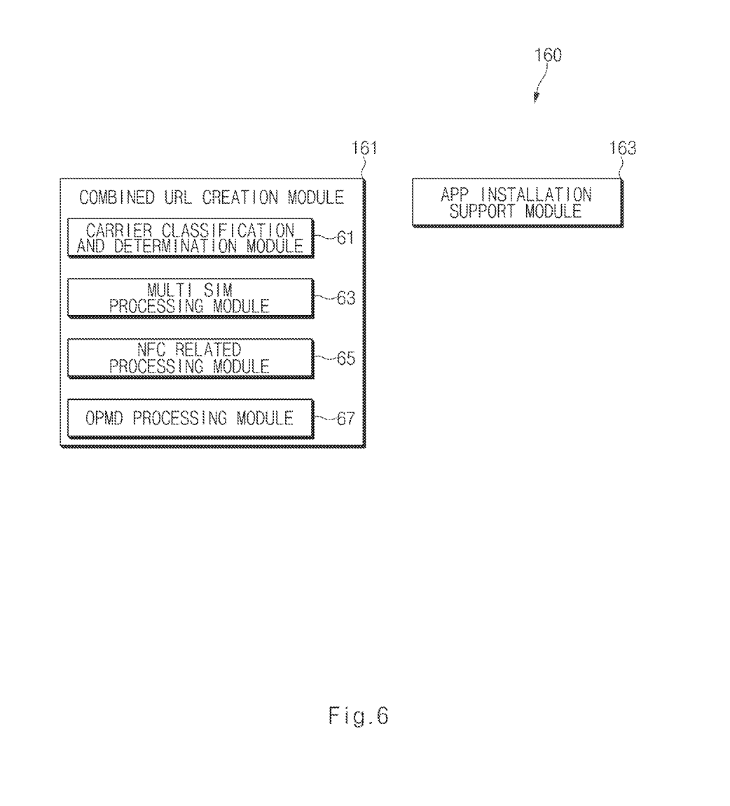

FIG. 6 shows a control module according to an embodiment of the present disclosure.

Referring to FIG. 6, the control module 160 may include a combined URL creation module 161 and an application installation support module 163.

The combined URL creation module 161 may include a carrier classification and determination module 61, a multi SIM processing module 63, an NFC-related processing module 65, and an OPMD processing module 67. The combined URL creation module 161 may use SIM information and address information on the server device 200 designated to create new path information URL from which an application is downloaded. The combined URL creation module 161 may create new path information based on at least one of operator classification based information, SIM related information on at least one of multiple SIMs, NFC related information, and OPMD related information.

The operator classification and determination module 61 may display the name of a service operator in a text form. For example, in order to identify the operator VODAFONE, the operator classification and determination module 61 may read SPN information written as “VODA” and limit a service operator. The operator classification and determination module 61 may combine service operator address information related to the SIM card 170 with SIM information to create the combined URL and control a connection to the server device 200 based on the combined URL.

When the electronic device 100 uses or may use the multi SIM card 170, the multi SIM processing module 63 may select a SIM card 170 in which an application is installed, among inserted SIM cards. According to an embodiment, when the multi SIM processing module 63 uses a dual SIM card supporting a Global System for Mobile (GSM) communication scheme and a Wideband-Code Division Multiple Access (WCDMA) communication scheme, it is possible to support the installation of applications suitable for each communication scheme. According to various embodiments, the multi SIM processing module 63 may first determine the SIM card 170 of a network service operator that may be serviced on the electronic device 100, and may check whether there is a limitation in capacity of data that may be used (hereinafter, referred to as “data usage limitation capacity”). The multi SIM processing module 63 may limit application installation when the data usage limitation capacity of the SIM card 170 currently usable is exceeded. When there is no limitation in data usage capacity of a corresponding SIM card 170, or when data usage capacity charged by a carrier sufficiently remains, the multi SIM processing module 63 may control application installation related to a corresponding SIM card 170. In this process, the multi SIM processing module 63 may enable a message related to data usage limitation capacity excess to be displayed.

The NFC-related processing module 65 may install a mobile payment function related application such as a smart wallet. In this context, the NFC-related processing module 65 may determine UICC information and install a related application. For example, the NFC-related processing module 65 may perform the processes of transmitting the SIM serial number among the ICC-ID of UICC and determining whether it is possible to use. In this process, the NFC-related processing module 65 may check whether an UICC function is used, through the communication between an NFC module chip and the SIM card 170 through a Single Wire Protocol (SWP) pin in the SIM card 170. When the UICC function may be used, the NFC-related processing module 65 may install a related application. As described above, the NFC-related processing module 65 may perform the process of determining SIM-NFC information through communication using the SWP between the electronic device 100 and the SIM card 170.

The OPMD processing module 67 may identify OPMD information among SIM information and check the presence of another electronic device sharing a data service fee subscribed to an operator. The OPMD processing module 67 may install an application similar to that of an electronic device that initially subscribes to a data service, when the SIM card 170 includes OPMD SIM information.

According to an embodiment, the OPMD processing module 67 may identify a SIM for OPMD by checking the SIM serial number of ICC-ID among SIM information, or through the model name of a SIM. In this context, the electronic device 100 may store a list of ICC-IDs related to the OPMD SIM. According to various embodiments, the OPMD processing module 67 may transmit the ICC-ID of the SIM card 170 to the server device 200 and check whether a corresponding SIM card 170 uses an OPMD service. Accordingly, the process of determining an OPMD SIM by the OPMD processing module 67 may include at least one of the process of checking SIM information and the process of checking based on the server device 200. When an OPMD SIM card is found, the OPMD processing module 67 may collect application information installed in an original electronic device and determine application information to be installed in a new electronic device. Alternatively, the OPMD processing module 67 may collect application information installed in the electronic device 100 through the server device 200 that recognizes that there is a SIM for OPMD.

When a connection to the server device 200 based on the combined URL created by the combined URL creation module 161 is performed, the server 200 may collect at least one application information needing to be installed in a corresponding electronic device 100 from combined URL information provided when a connection is performed. The server device 200 may create a list of applications based on at least one application information and provide the list of applications for the application installation support module 163 of the electronic device 100.

The application installation support module 163 may enable the list of applications provided by the server device 200 to be displayed on the display module 140. The application installation support module 163 may enable application item selection information on a specific application item determined among the list of applications to be transmitted to the server 200. The application installation support module 163 may install a corresponding application based on application installation information provided by the server device 200. In this process, the application installation support module 163 may transmit application package selection information to the server device 200 and receive application installation information on a plurality of applications related to an application package from the server device 200. The application installation support module 163 may install an application based on application installation information related to the applications.

Various embodiments may be implemented in a recording medium that may be read with a computer or a similar device by using software, hardware or a combination thereof. According to a hardware implementation, the embodiments may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers), microprocessors, and other electrical units for performing functions. In some cases, the embodiments described in the specification may be implanted as the control module 160 itself. According to a software implementation, embodiments such as procedures and functions described in the specification may be implemented in separate software modules. Each of the software modules may perform one or more functions and operations that are described in the specification.

According to various embodiments, the control module 160 of the above-described electronic device 100 may include buses and at least one processor. In this example, the processor may include, for example, at least one of the combined URL creation module and the application installation support module that are described with respect to the electronic device 100.

The buses may be circuits that connect components (such as processors, storage modules, input modules, display modules or communication modules) included in electronic devices and that transfer communication (such as control messages) between the components.

The processor may receive commands through the buses from the components included in the electronic devices, decrypt the received commands and perform calculation or data processing according to the decrypted commands. In this case, the processor executes at least one application stored in the storage module 150 and provides a service based on a corresponding application.

Also, the processor may include one or more Application Processors (APs) or one or more Communication Processors (CPs). In this example, the AP or the CP may be included in a processor or they may be included in different IC packages respectively. Also, the AP or the CP may also be included in one IC package. The AP may execute an OS or application programs to control a plurality of hardware and software components connected to the AP and may perform processing and calculation on various data including multimedia data. In this example, the AP may be implanted in a System on Chip (SoC). Also, the CP may perform at least some of multimedia control functions. Also, the CP may use a subscriber identification module (such as a SIM card) to identify and authenticate terminals in a communication network. In this case, the CP may provide a service including a voice call, video call, text message or packet data service. Also, the CP may perform the data transmission/reception of the communication module 260. The AP or the CP may load, on volatile memories, commands or data received from non-volatile memories connected to the AP or the CP or from at least one of other components and may process the commands or data. Also, the AP or the CP may store, on non-volatile memories, data received from at least one of other components or generated by at least one of other components. The CP may manage a data link when communication is performed between other electronic devices connected to an electronic device including hardware through a network, and perform a function of converting a communication protocol. In this example, the CP may be implanted in a SoC. Furthermore, the processor may further include a Graphic Processing Unit (GPU).

As described above, the electronic device 100 according to an embodiment may include a SIM card that stores SIM information, a control module that combines the SIM information with the stored address information of a server device to create combined address information, controls a server device connection based on the combined address information, and controls the reception of a list of applications including information related to application installation or update corresponding to the type of the SIM information, and a communication module that establishes a communication channel in the process that the server device connects.

According to various embodiments, the SIM card may support SIM based data operation including at least one SIM card including SIM information corresponding to a specific carrier.

According to various embodiments, the control module may check data usage capacity of a determined one of at least one SIM card, and limit the reception of information related to the application installation or update through the communication module when the data usage capacity exceeds limitation capacity.

According to various embodiments, the electronic device may further include a display module displaying the list of applications.

According to various embodiments, when an event to select the application installation or update related information is received, the communication module may transmit a selection event to the server device and receive application installation information in response to the selection event.

According to various embodiments, the control module may control application installation corresponding to application installation information received from the server device.

According to various embodiments, the electronic device may further include a display module that displays the list of applications including an application package item enabling a plurality of applications related to the SIM information to be installed as a package.

According to various embodiments, when an event to select the application package item is received, the communication module may transmit an application package item selection event to the server device and receive an application package including the applications.

According to various embodiments, the control module may receive application installation information corresponding to the application package from the server device and enable applications corresponding to the application installation information to be installed.

According to various embodiments, the display module may include at least one of an application package item corresponding to a specific network service operator identified based on carrier information including at least one of MCC, MNC, SPN, and GID included in the SIM information, an application item related to a SIM card corresponding to SIM information that currently uses or may use a data service, among a plurality of SIM cards, an application item based on NFC information or financial transaction related information included in the SIM information, a carrier application item of another electronic device related to data sharing among the SIM information, and an application item corresponding to application store information among the SIM information.

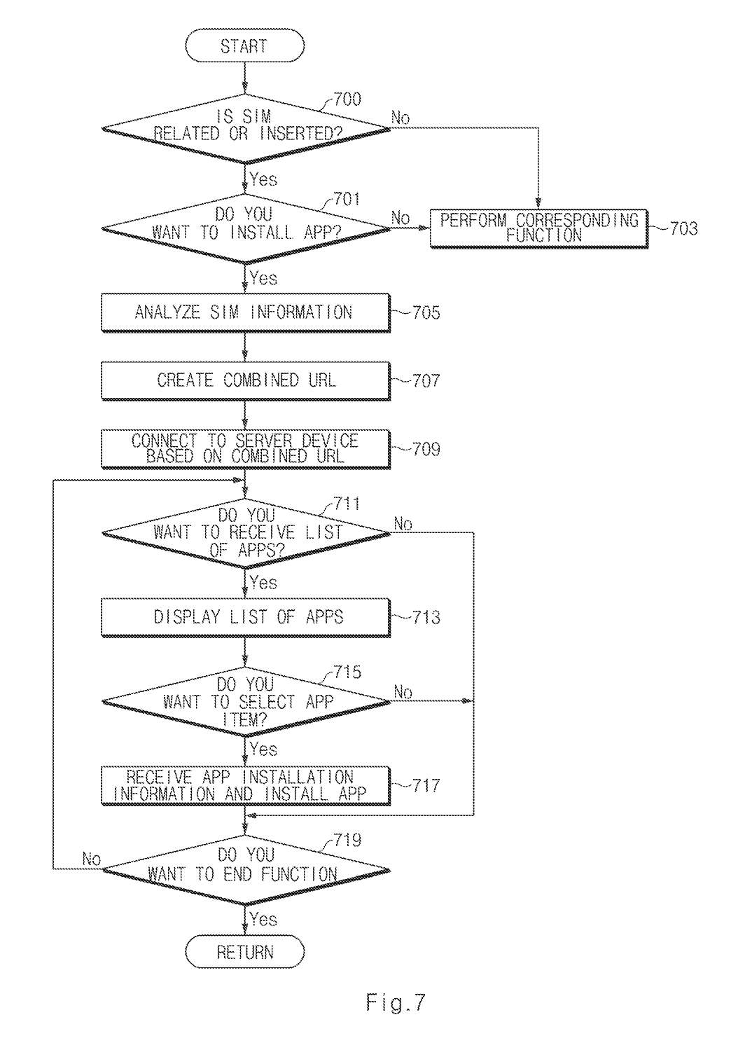

FIG. 7 shows a method of operating an electronic device according to an embodiment of the present disclosure.

Referring to FIG. 7, in the method of operating the electronic device, the control module 160 may check whether an event related to application installation occurs, in operation 701. According to an embodiment, the control module 160 may check whether the SIM card 170 is replaced or a new SIM card 170 is inserted, in operation 700. When the SIM card 170 is replaced or newly inserted in operation 700, the control module 160 may automatically detect SIM information on the SIM card 170. The control module 160 may automatically cause an event related to application installation relating to SIM information. Accordingly, in operation 701, an application installation related event may automatically occur by the insertion of the SIM card 170.

According to various embodiments, the control module 160 may sound the alarm with respect to the insertion of the new SIM card 170 and display a check window inquiring whether to perform application installation related to a corresponding to SIM card 710, in operation 700. Accordingly, the control module 160 may check whether a check request related to application installation occurs, in operation 701. When there is no SIM card 170 replacement or insertion, the control module 160 may proceed to operation 703 to perform a scheduled function or a corresponding function caused by an input event.

In operation 701, the control module 160 may perform a function corresponding to the type of an event in operation 703, when a specific event caused is not an event related to application installation. For example, the control module 160 may perform a sound play function, support a broadcast reception function or perform a gallery function, according to the type of an event.

When an event related to application installation occurs in operation 701, the control module 160 may analyze SIM information in operation 705. For example, the control module 160 may check whether SIM information includes at least one of ICC-ID information, MCC/MNC information, NFC link information, multi SIM information, and OPMD information included in the SIM card 170.

The control module 160 may create the combined URL in operation 707. The control module 160 may combine identified SIM information with designated address information on the server device 200 to create the combined URL. In this example, the server device 200 may include specific information written in SIM information or address information on the server device 200 related to a specific application.

The control module 160 may connect to the server 200 based on the combined URL in operation 709. When a connection to a corresponding server device 200 is performed by using combined URL, the server device 200 may extract SIM information and UA information corresponding to device related information on the electronic device 100. The server device 200 may detect at least one application necessary to the electronic device 100 based on SIM information and UA information. The server device 200 may create a list of applications including at least one application and transmit the list to the electronic device 100. In this example, the list of applications may include at least one application package.

The control module 160 may check whether the list of applications is received from the server device 200, in operation 711. When the list of applications is received, the control module 160 may display the list of applications on the display module 140, in operation 713. The control module 160 may check whether an event related to application item selection occurs, in operation 715. In this context, the control module 160 may check whether an event to select a specific application item occurs in at least one of the display module 140 and the input module 120.

The control module 160 may transmit application item selection information to the server device 200, when an event related to application item selection occurs in operation 715. Accordingly, the control module 160 may receive application installation information corresponding to corresponding application item selection information from the server device 200 and perform application installation in operation 717.

The control module 160 may check whether an event related to a function end occurs, in operation 719. When there is no function end related event, the control module 160 may return to process 711 to re-perform related processes. When the function end related event occurs, the control module 160 may proceed to process 703 to perform a specific function supported by the electronic device 100.

As described above, the method of operating the electronic device according to an embodiment may include the process of collecting SIM information on a SIM card of the electronic device, the process of combining collected SIM information with stored address information on a server device to create combined address information by the electronic device, a process in which the electronic device connects to the server device based on the combined address information, and a process in which the electronic device receives a list of applications including information related to application installation or update according to the characteristic of the SIM information.

According to various embodiments, the process of collecting may include the process of collecting SIM information on a SIM card determined among at least one SIM card included in the electronic device.

According to various embodiments, the method may further include the process of checking the data usage capacity of the determined SIM card, and the process of limiting information reception related to the application installation when the data usage capacity exceeds limitation capacity.

According to various embodiments, the method may further include the process of displaying the list of applications on the display module of the electronic device.

According to various embodiments, the method may further include the process of receiving an even to selection at least one application item included in the list of applications and the process of transmitting application item selection information to the server device by the electronic device.

According to various embodiments, the method may further include the process of receiving, by the electronic device, application installation information corresponding to the application item selection information from the server device and the process of installing, by the electronic device, an application corresponding to the application installation information.

According to various embodiments, the method may further include the process of displaying, by the electronic device, an application package item enabling a plurality of applications related to the SIM information to be installed as a package.

According to various embodiments, the method may further include the process of receiving, by the electronic device, an event to select the application package item, the process of transmitting, by the electronic device, the application package item selection information to the server device, the process of receiving, by the electronic device, application installation information related to a plurality of applications from the server device, and the process of installing, by the electronic device, applications corresponding to the application installation information.

According to various embodiments, the process of receiving the list of applications may include at least one of an application package item corresponding to a specific network service operator identified based on carrier information including at least one of MCC, MNC, SPN, and GID included in the SIM information, an application item related to a SIM card corresponding to SIM information that currently uses or may use a data service, among at least one SIM card, an application item based on NFC information or financial transaction related information included in the SIM information, a carrier application item of another electronic device related to data sharing among the SIM information, and an application item corresponding to application store information included in the SIM information.

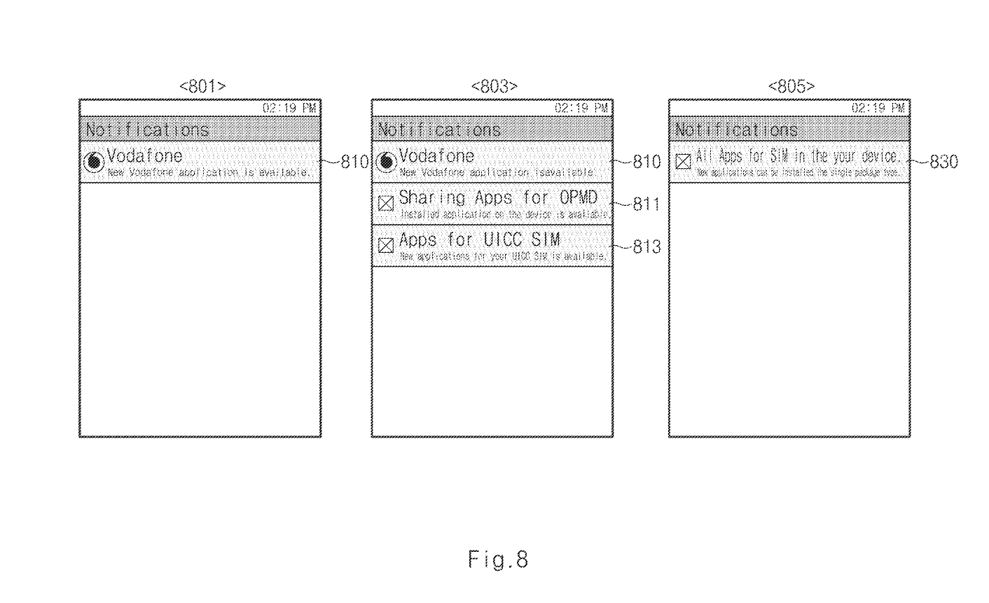

FIG. 8 shows a screen interface according to an embodiment of the present disclosure.

Referring to FIG. 8, the display module 140 may display application related notification information 810 in a notification area as shown in screen 801, when there is notification information related to application installation of the electronic device 100. The application related notification information 810 may include the capacity of an application package to be installed, application package provider information, and application information in a package. According to an embodiment, the application related notification information 810 may be transferred through content-length information among HyperText Transfer Protocol (HTTP) header information. The application related notification information transferred may be displayed on a certain area of the display module 140, such as a notification area.

When an input event related to user selection for specific items among the application related notification information 810 occurs, the control module 160 may perform application installation. According to an embodiment, when the application related notification information 810 displayed on the notification area of the display module 140 is selected as shown in screen 803, the display module 140 may display application items 811 and 813.

When an event to select any one of the application items occurs, the control module 160 may control whether to display a popup window that inquires user permission for an application item to be installed. In this process, when an input event corresponding to permission is received, the control module 160 may connect to the server device 200 through a designated application address, and download an application package corresponding to the application items 811 and 813, from the server device 200. The control module 160 may automatically install applications included in the package when the application package is downloaded. Accordingly, the display module 140 may display installation completion information 830 on specific applications for determined application items as shown in screen 805.

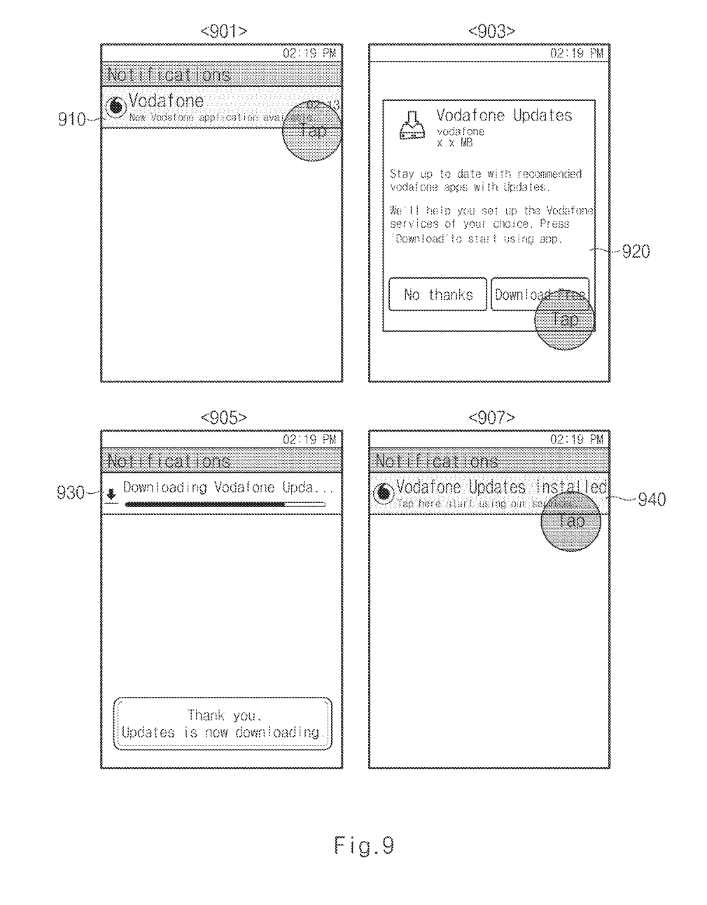

FIG. 9 shows a screen interface according to another embodiment of the present disclosure.

Referring to FIG. 9, the electronic device 100 may display update related notification information 910 related to update information on an installed application or update information to be installed in a corresponding electronic device 100 according to the insertion of a specific SIM card 170, on the display module 140 as shown in screen 901. When the update related notification information 910 is selected, the display module 140 may display an update related popup window 920 as shown on a screen 903. When an input event to instruct downloading occurs on the update related popup window 920, the display module 140 may display screen information 930 performing update related data downloading as shown on a screen 905. When the downloading of update related data is completed, the control module 160 may perform the application update of the electronic device 100 based on received update information. In addition, when the update is completed, the control module 160 may display update completion notification information 940 on the display module 140 as shown in screen 907.

According to various embodiments, the control module 160 may limit application installation according to a user choice when the multi SIM card 170 is inserted at the electronic device 100. For example, SIM cards related to operators A and B may be inserted and the electronic device 100 may use data services of operators A and B. In this example, according to an employed fee type, data usage limitation capacity charged by operator A may be exceeded and data usage limitation capacity charged operator by operator B may remain. When a user connects to the network of the operator A through a SIM card related to the operator A, the control module 160 may not perform an installation process even if the user selects the application related notification information 810 or the update related notification information 910. In addition, the control module 160 may control a message output related to a data usage capacity excess state related to operator A related SIM card usage. After a user connects to the network of the operator B through a SIM card related to the operator B, the control module 160 may perform a corresponding application or update installation if the user selects the application related notification information 810 or the update related notification information 910.

According to various embodiments, the control module 160 may limit an installation process according to a user choice when a remaining memory space is insufficient when compared to an application size. In this process, the control module 160 may enable an alarm related to a remaining memory storage space insufficiency, to be output. The control module 160 may enable a message requesting memory cleanup to be displayed. Alternatively, the control module 160 may enable memory cleanup to be automatically performed. When a memory has a free space, the control module 160 may enable a corresponding application installation process to be performed.

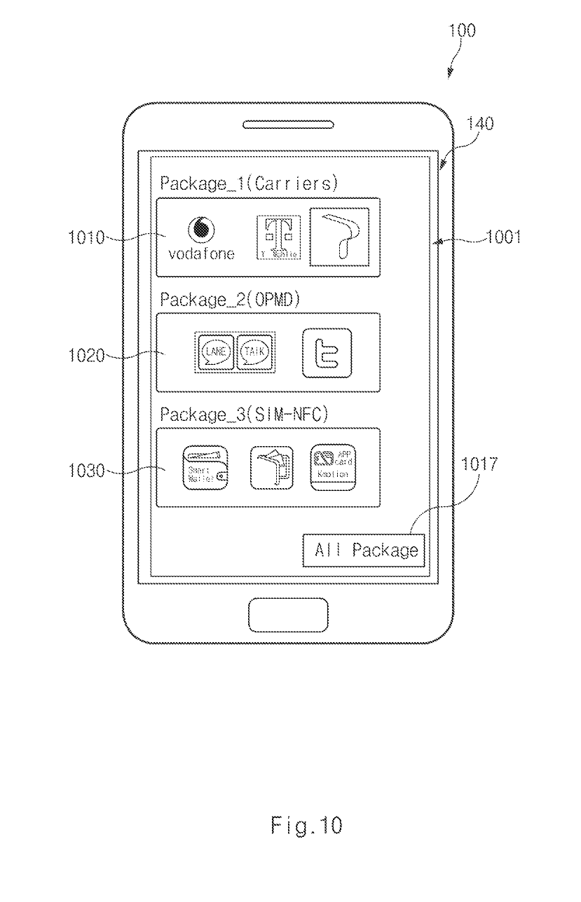

FIG. 10 shows a screen interface according to an embodiment of the present disclosure.

Referring to FIG. 10, the electronic device 100 may combine SIM information on a specific SIM card 170 with defined address information on the server device 200 and connect to the server device 200 based on combined URL. The electronic device 100 may receive a list of applications corresponding to SIM information from the server device 200. Accordingly, the display module 140 may display a list of applications 1001 as shown in FIG. 10. The list of applications 1001 may vary depending on SIM information. The list of applications 1001 presented in FIG. 10 illustrates a list that includes a first application item 1010 corresponding to when a multi SIM card is inserted, a second application item 1020 corresponding to an OPMD SIM card, and a third application item 1030 related to a SIM-NFC characteristic. In this context, the electronic device 100 may include multiple SIM cards, at least one of inserted SIM cards has an OPMD SIM characteristic and a specific SIM has an NFC characteristic. According to an embodiment, when the electronic device 100 operates only multiple SIM cards, the electronic device 100 may receive and display a list of applications including the first application item 1010 from the server device 200. According to an embodiment, when the electronic device 100 operates an OPMD SIM card, the display module 140 may display a list of applications including only the second application item 1020. Also, when the electronic device 100 has an SIM-NFC characteristic related to an UICC function, the display module 140 may display a list of applications including only the third application item 1030.

When at least one of application items 811 and 813 included in the list of applications 1001 is selected, the electronic device may request the server device 200 to transfer application installation information on a determined application item. The server device 200 may provide application installation information corresponding to application item selection information. In this process, the server device 200 may provide, application package installation information on a plurality of applications included in an application item, for the electronic device 100. According to various embodiments, the list of applications may include an integrated application installation item 1017. When the integrated application installation item 1017 is selected, the server device 200 may configure a plurality of applications related to the application items 811 and 813 as one package and provide it for the electronic device 100.

As described above, various embodiments of the SIM based data operation method and the electronic device supporting the method may provide various applications according to the SIM cards inserted into the electronic device. Accordingly, the manufacturer of the electronic device may reduce costs because there is no need to install and manufacture an application by carrier. For example, a manufacturer may configure various line-ups for a product in an open market, without considering a carrier. A carrier may also reduce promotion costs for an application installation guidance to a specific user, and thus focus on a user and provide an optimized application.

As discussed above, various embodiments of the SIM based data operation method and the electronic device supporting the method may enable at least one desired application to be more easily searched for and installed based on SIM information.

Also, various embodiments may provide necessarily used or most used applications as a package form based on SIM information to enable the installation and operation of a plurality of applications to be processed more easily.

Also, various embodiments enable user-specific applications to be installed and operated easily and quickly based on a SIM information based application installation history.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a Subscriber Identity Module (SIM) card configured to store SIM information;
a control module configured to combine the SIM information with stored address information of a server device to create combined address information, to control a connection with the server device based on the combined address information, and to control a reception of a list of applications comprising information related to application installation or update corresponding to a type of the SIM information; and
a communication module configured to establish communication with the server device.

2. The electronic device according to claim 1, wherein the SIM card supports a SIM based data operation including at least one SIM information corresponding to a specific carrier.

3. The electronic device according to claim 2, wherein the control module checks data usage capacity of the SIM card corresponding to determined SIM information among the at least one SIM information, and limits the reception of information related to the application installation or update through the communication module when the data usage capacity exceeds a limitation capacity.

4. The electronic device according to claim 1, further comprising:
a display module configured to display the list of applications.

5. The electronic device according to claim 4, wherein, when a selection event for the information related to the application installation or update is received, the control module transmits the selection event to the server device and receives application installation information in response to the selection event.

6. The electronic device according to claim 5, wherein the control module controls application installation corresponding to application installation information received from the server device.

7. The electronic device according to claim 1, further comprising:
a display module configured to display the list of applications including an application package item that enables a plurality of applications related to the SIM information to be installed as a package.

8. The electronic device according to claim 7, wherein, when an event to select the application package item is received, the control module transmits the event to select the application package item to the server device and receives an application package including the plurality of applications.

9. The electronic device according to claim 8, wherein the control module receives pieces of application installation information corresponding to the application package from the server device and controls the installation of applications corresponding to the pieces of application installation information.

10. The electronic device according to claim 1, wherein the display module displays a list of applications including at least one of an application package item corresponding to a specific network service operator identified based on carrier information including at least one of a Mobile Country Code (MCC), a Mobile Network Code (MNC), a Service Provider Name (SPN), and Group Infrastructure Desktop (GID) included in the SIM information, an application item related to a SIM card corresponding to SIM information that currently uses or may use a data service, among a plurality of SIM cards, an application item based on Near Field Communication (NFC) information or financial transaction related information included in the SIM information, a carrier application item of another electronic device related to data sharing among the SIM information, and an application item corresponding to application store information among the SIM information.

11. A Subscriber Identity Module (SIM) based data operation method, the method comprising:
collecting SIM information on a SIM card of an electronic device;
combining, by the electronic device, collected SIM information with stored address information of a server device to create combined address information;
connecting, by the electronic device, to the server device based on the combined address information; and
receiving, by the electronic device, a list of applications including information related to application installation or update according to a characteristic of the SIM information.

12. The method according to claim 11, wherein the collecting comprises collecting SIM information determined among at least a piece of SIM information included in the electronic device.

13. The method according to claim 12, further comprising:
checking a data usage capacity related to a SIM card corresponding to determined SIM information; and
limiting a reception of information related to the application installation when the data usage capacity exceeds a preset limitation capacity.

14. The method according to claim 11, further comprising:
displaying the list of applications on a display module of the electronic device.

15. The method according to claim 14, further comprising:
receiving at least one application item selection event included in the list of applications; and
transmitting, by the electronic device, the application item selection information to the server device.

16. The method according to claim 15, further comprising:
receiving, by the electronic device, application installation information corresponding to the application item selection information from the server device; and
installing, by the electronic device, an application corresponding to the application installation information.

17. The method according to claim 14, further comprising:
displaying, by the electronic device, an application package item that enables a plurality of applications related to the SIM information to be installed as a package.

18. The method according to claim 17, further comprising:
receiving, by the electronic device, an event to select the application package item;
transmitting, by the electronic device, the application package item selection information to the server device;
receiving, by the electronic device, application installation information related to the plurality of applications from the server device; and
installing, by the electronic device, applications corresponding to the application installation information.

19. The method of claim 11, wherein the receiving comprising at least one of:
an application package item corresponding to a specific network service operator identified based on carrier information including at least one of a Mobile Country Code (MCC), a Mobile Network Code (MNC), a Service Provider Name (SPN), and Group Infrastructure Desktop (GID) included in the SIM information;
an application item related to a SIM card corresponding to SIM information that currently uses or may use a data service, among at least one SIM card, an application item based on Near Field Communication (NFC) information or financial transaction related information included in the SIM information;
a carrier application item of another electronic device related to data sharing included in the SIM information; and
an application item corresponding to application store information included in the SIM information.

20. A server device comprising:
a server communication module configured to establish a communication channel with an electronic device connecting to a server device based on combined address information obtained by combining Subscriber Identity Module (SIM) information with stored address information on the server device;
a server control module configured to extract the SIM information from the combined address information, and to transmit a list of applications comprising information related to installation or update of at least one application corresponding to the characteristic of extracted SIM information, to the electronic device; and
a server storage module configured to store information related to the installation or update of the application.
